(19) United States
(12) Patent Application Publication
(10) Pub. No.: US 2020/0394845 A1
(43) Pub. Date: Dec. 17, 2020

(54) VIRTUAL OBJECT DISPLAY CONTROL DEVICE, VIRTUAL OBJECT DISPLAY SYSTEM, VIRTUAL OBJECT DISPLAY CONTROL METHOD, AND STORAGE MEDIUM STORING VIRTUAL OBJECT DISPLAY CONTROL PROGRAM

(71) Applicant: Mitsubishi Electric Corporation, Tokyo (JP)

(72) Inventors: Fengyi JIN, Tokyo (JP); Masaya NIDAIRA, Tokyo (JP)

(73) Assignee: Mitsubishi Electric Corporation, Tokyo (JP)

(21) Appl. No.: 16/971,502

(22) PCT Filed: Feb. 26, 2018
(86) PCT No.: PCT/JP2018/006950

§ 371 Date: Aug. 20, 2020

(51) Int. Cl. G06T 19/00; G06T 15/20; G06T 7/593; G06T 7/70; G06F 3/14; G06F 3/01

(52) U.S. Cl. CPC G06T 19/006; G06T 15/20; G06T 7/593; G06T 2219/004; G06F 3/14; G06F 3/011; G06T 7/70

(57) ABSTRACT

A virtual object display control device includes a recognition unit to receive real space information, a viewpoint position judgment unit to judge a position of a viewpoint of an observer, a real object judgment unit to judge a position and a shape of a real object, a virtual object display setting unit to set image information on a virtual object based on the position of the viewpoint and the position and the shape of the real object, a guidance display control unit to judge whether a guidance display is necessary based on the position of the viewpoint, the position and the shape of the real object, and the image information on the virtual object and to set image information on the guidance display when the guidance display is necessary, and a drawing unit to output the image information on the virtual object and the image information on the guidance display.

### TECHNICAL FIELD

The present invention relates to a virtual object display control device, a virtual object display control method and a virtual object display control program for performing control for displaying an image of a virtual object, and to a virtual object display system including the virtual object display control device.

### BACKGROUND ART

There has been proposed a device that displays an image of a real object and an image of a virtual object superimposed on the former image on the screen of a display device (see Patent References 1 and 2, for example). The image of the virtual object is an augmented reality (AR) image, for example.

### PRIOR ART REFERENCE

### Patent Reference

Patent Reference 1: Japanese Patent Application Publication No. 2015-49039 (paragraphs 0010, 0068 and 0079)

Patent Reference 2: WO 2016/203792 (paragraph 0081)

### SUMMARY OF THE INVENTION

### Problem to be Solved by the Invention

In the aforementioned conventional device, the image of the virtual object is displayed at a position shifted from a position where the image should originally be displayed, by taking into account the occlusion in the real space (i.e., so that the image of the virtual object is not hidden by the image of the real object). In this case, however, the observer cannot learn the position where the image of the virtual object should originally be displayed. Accordingly, when the image of the virtual object is an image including an annotation on a real object, it is unclear on which real object the annotation is.

The object of the present invention is to provide a virtual object display control device, a virtual object display system, a virtual object display control method, and a virtual object display control program capable of allowing the observer to recognize the position of the image of the virtual object even when the image of the virtual object is displayed at a position invisible from the observer.

### Means for Solving the Problem

A virtual object display control device according to an aspect of the present invention includes a recognition unit to receive real space information indicating a real space; a viewpoint position judgment unit to judge a position of a viewpoint of an observer based on the real space information; a real object judgment unit to judge a position and a shape of a real object based on the real space information; a virtual object display setting unit to set image information on a virtual object based on the position of the viewpoint and the position and the shape of the real object; a guidance display control unit to judge whether a guidance display is necessary or not based on the position of the viewpoint, the position and the shape of the real object, and the image information on the virtual object and to set image information on the guidance display when the guidance display is necessary; and a drawing unit to output the image information on the virtual object and the image information on the guidance display.

A virtual object display system according to another aspect of the present invention includes a space information acquisition unit to acquire real space information indicating a real space; a recognition unit to receive the real space information; a viewpoint position judgment unit to judge a position of a viewpoint of an observer based on the real space information; a real object judgment unit to judge a position and a shape of a real object based on the real space information; a virtual object display setting unit to set image information on a virtual object based on the position of the viewpoint and the position and the shape of the real object; a guidance display control unit to judge whether a guidance display is necessary or not based on the position of the viewpoint, the position and the shape of the real object, and the image information on the virtual object and to set image information on the guidance display when the guidance display is necessary; a drawing unit to output the image information on the virtual object and the image information on the guidance display; and a display device to display an image based on the image information on the virtual object and the image information on the guidance display.

### Effect of the Invention

According to the present invention, even when the image of the virtual object is displayed at a position invisible from the observer, it is possible to allow the observer to recognize the position of the image of the virtual object by means of the guidance display.

### BRIEF DESCRIPTION OF THE DRAWINGS

FIG. 1 is a diagram showing a hardware configuration of a virtual object display system according to a first embodiment of the present invention.

FIG. 2 is a diagram schematically showing a positional relationship between a position of a viewpoint and a real object (occluding object).

FIG. 3 is a functional block diagram showing a virtual object display control device according to the first embodiment.

FIG. 4 is an explanatory diagram showing the virtual object display system according to the first embodiment.

FIG. 5 is a flowchart showing the operation of the virtual object display control device according to the first embodiment.

FIG. 6 is a diagram showing a hardware configuration of a virtual object display system according to a modification of the first embodiment.

FIG. 7 is an explanatory diagram showing the virtual object display system according to the modification of the first embodiment.

FIG. 8 is a diagram showing a hardware configuration of a virtual object display system according to a second embodiment of the present invention.

FIG. 9 is an explanatory diagram showing the virtual object display system according to the second embodiment.

### MODE FOR CARRYING OUT THE INVENTION

Virtual object display control devices, virtual object display systems, virtual object display control methods and virtual object display control programs according to embodiments of the present invention will be described below with reference to the accompanying drawings. The following embodiments are just examples and a variety of modifications are possible within the scope of the present invention.

Incidentally, an xyz orthogonal coordinate system is shown in the drawings. In the xyz orthogonal coordinate system, the x-axis represents a transverse direction (i.e., horizontal transverse direction) in the real space, the y-axis represents a depth direction (i.e., horizontal depth direction) in the real space, and the z-axis represents a height direction (i.e., vertical direction) in the real space.

### First Embodiment

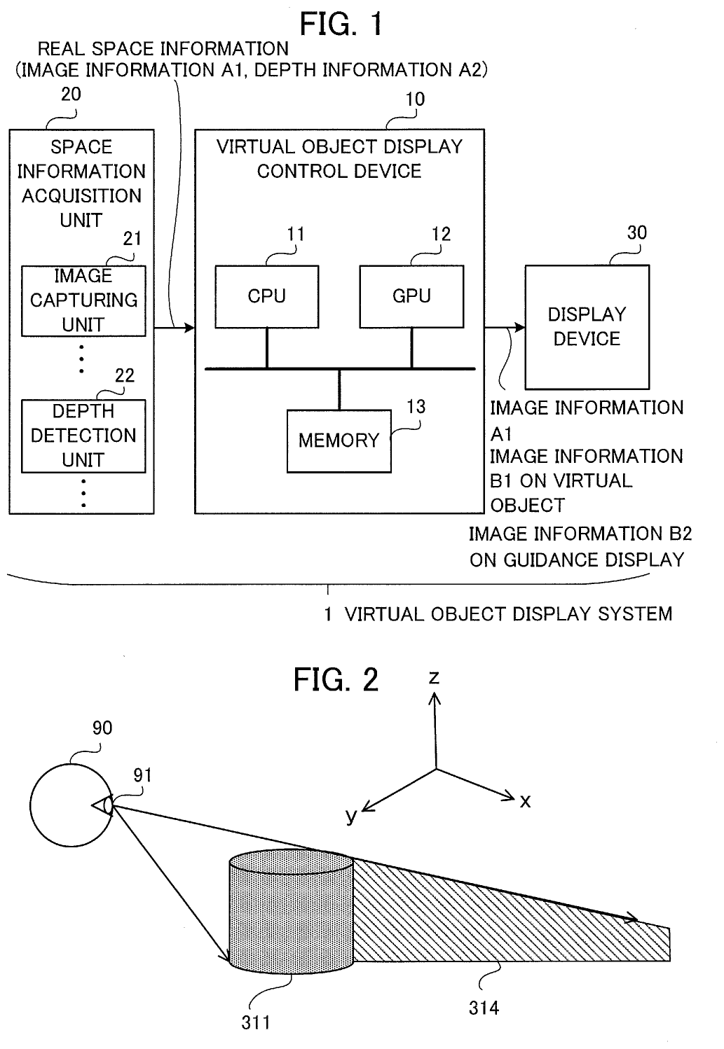

First, a configuration of a virtual object display system 1 and a virtual object display control device 10 will be described below. FIG. 1 is a diagram showing a hardware configuration of the virtual object display system 1 according to a first embodiment. As shown in FIG. 1, the virtual object display system 1 includes a space information acquisition unit 20 as a space detection unit that acquires real space information indicating a real space (i.e., real world), a display device 30 that displays an image, and the virtual object display control device 10 that makes the display device 30 display the image. The display device 30 displays an image of a real object, an image of a virtual object, and a guidance display, for example. The image of the virtual object is an AR image, for example. The virtual object display control device 10 is a device capable of executing a virtual object display control method according to the first embodiment.

The space information acquisition unit 20 includes, for example, one or more image capturing units 21 for acquiring image information A1 on the real space and one or more depth detection units 22 for acquiring depth information A2 on a real object (i.e., object) existing in the real space. The space information acquisition unit 20 may be configured to include one of the image capturing unit 21 and the depth detection unit 22. The image capturing unit 21 is, for example, a color camera that acquires a color image, a stereo camera that simultaneously captures images of a real object from a plurality of different directions, or the like. The depth detection unit 22 is, for example, a depth camera having a function of detecting the depth (deepness) of a real object, or the like. In the first embodiment, the real space information includes the image information A1 on the real space and the depth information A2 on the real object.

The virtual object display control device 10 includes a CPU (Central Processing Unit) 11 as an information processing unit, a GPU (Graphics Processing Unit) 12 as an image processing unit, and a memory 13 as a storage unit for storing information. Functions of the GPU 12 may be executed by the CPU 11. The virtual object display control device 10 is, for example, a personal computer (PC), a smartphone, a tablet terminal, or the like. The memory 13 may store a virtual object display control program according to the first embodiment. The CPU 11 is capable of controlling a display operation of the display device 30 by executing the virtual object display control program.

The display device 30 is, for example, a device having a display screen (i.e., display), such as a PC monitor, a smartphone or a tablet terminal.

FIG. 2 is a diagram schematically showing a positional relationship between a position 91 of a viewpoint of an observer 90 and a real object 311. The real object 311 can exist as a occluding object that hides a virtual object. When the real object 311 exists in the real space, the observer 90 cannot view an image of a virtual object displayed in a region (hatched region) 314 hidden by the real object 311 from the position 91 of the viewpoint. Further, when the image of the virtual object is moved to a different position, it becomes unclear to which real object the image of the virtual object is related. Therefore, the virtual object display control device 10 judges the position 91 of the viewpoint of the observer 90 and the position and the shape of the real object 311 based on the real space information, and judges whether a guidance display is necessary or not based on the position 91 of the viewpoint, the position and the shape of the real object 311, and image information B1 on the virtual object. When the guidance display is necessary, the virtual object display control device 10 sets image information B2 on the guidance display and outputs the image information B1 on the virtual object and the image information B2 on the guidance display. When the guidance display is unnecessary, the virtual object display control device 10 outputs the image information B1 on the virtual object.

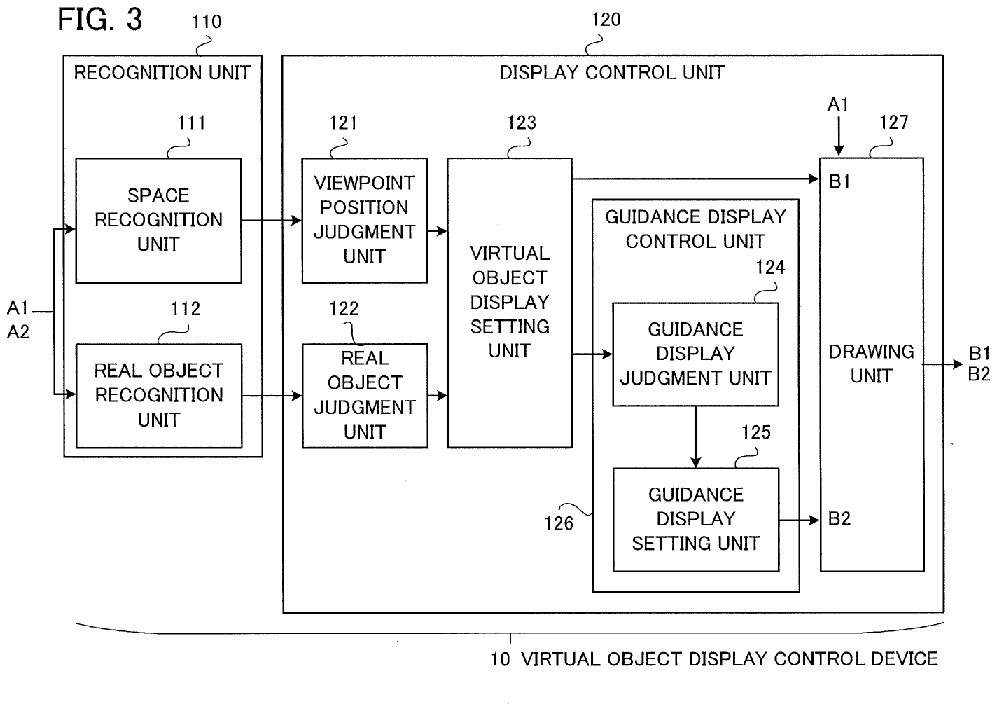

FIG. 3 is a functional block diagram showing the virtual object display control device 10 according to the first embodiment. As shown in FIG. 3, the virtual object display control device 10 includes a recognition unit 110 that receives the image information A1 on the real space and the depth information A2 on the real object as the real space information and a display control unit 120.

The recognition unit 110 includes, for example, a space recognition unit 111 that receives the image information A1 on the real space, performs necessary processing, and supplies the result to the display control unit 120 and a real object recognition unit 112 that receives the depth information A2 on the real object, performs necessary processing, and supplies the result to the display control unit 120. The real object recognition unit 112 may output data in which the real object has been replaced with a model of the real object (i.e., previously stored image information). The model of the real object, as previously stored image information, may be image information on a desk, a chair or the like, or a typical three-dimensional shape such as a cylinder, a rectangular prism, a triangular pyramid or a sphere. However, the configuration and the functions of the recognition unit 110 are not limited to the above-described examples.

The display control unit 120 includes a viewpoint position judgment unit 121 that judges the position 91 of the viewpoint of the observer 90 based on the image information A1 on the real space and the depth information A2 on the real object, a real object judgment unit 122 that judges the position and the shape of the real object 311 based on the real space information, and a virtual object display setting unit 123 that sets the image information B1 on the virtual object 312 based on the position 91 of the viewpoint and the position and the shape of the real object 311.

Further, the display control unit 120 includes a guidance display judgment unit 124 that judges whether the guidance display 323 is necessary or not based on the position 91 of the viewpoint, the position and the shape of the real object 311, and the image information B1 on the virtual object 312 and a guidance display setting unit 125 that sets the image information B2 on the guidance display when the guidance display 323 is necessary. The guidance display judgment unit 124 and the guidance display setting unit 125 constitute a guidance display control unit 126. The guidance display judgment unit 124 judges that the guidance display is necessary when the whole or part of the virtual object is hidden by the real object as viewed from the position of the viewpoint, for example. Alternatively, the guidance display judgment unit 124 may judge that the guidance display is necessary when a predetermined certain proportion or more (e.g., 50% or more) of the virtual object is hidden by the real object as viewed from the position of the viewpoint.

Furthermore, the display control unit 120 includes a drawing unit 127 that outputs the image information B1 on the virtual object and the image information B2 on the guidance display. It is also possible for the drawing unit 127 to output synthetic image information obtained by combining the image information B1 on the virtual object and the image information B2 on the guidance display with the image information A1 on the real space.

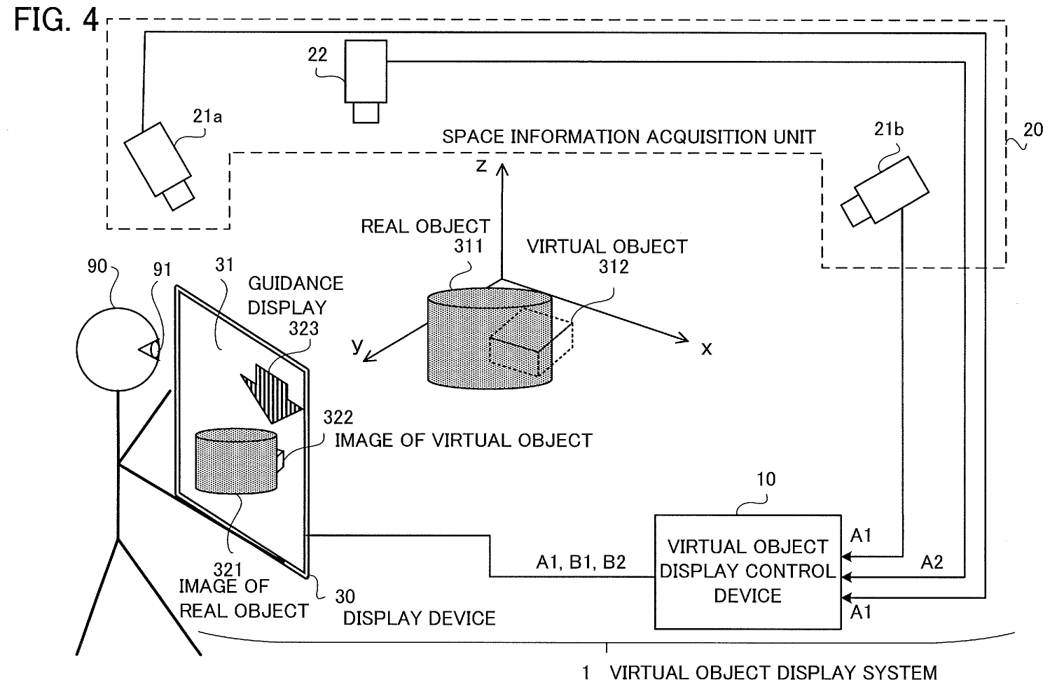

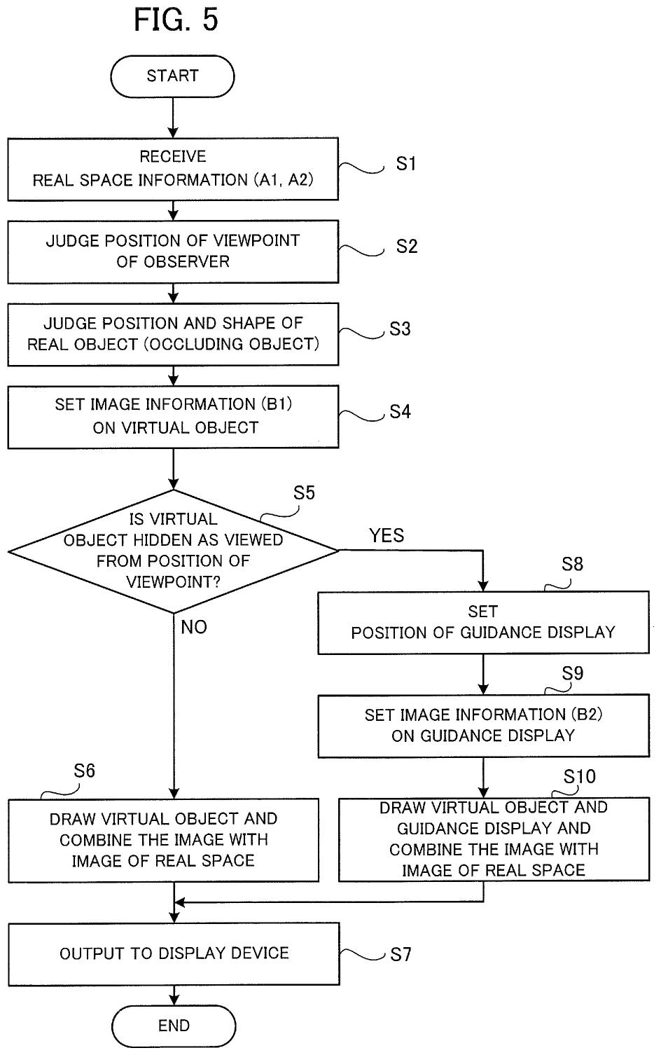

Next, the operation of the virtual object display control device 10 will be described below. FIG. 4 is an explanatory diagram showing the virtual object display system 1. In FIG. 4, two image capturing units 21a and 21b are shown as the image capturing unit 21 in FIG. 1. In the example of FIG. 4, the image capturing units 21a and 21b of the space information acquisition unit 20 supply the image information A1 on the real space and the depth information A2 on the real object to the virtual object display control device 10. FIG. 5 is a flowchart showing the operation of the virtual object display control device 10.

The virtual object display control device 10 receives the real space information in step S1, judges the position 91 of the viewpoint of the observer 90 based on the real space information (e.g., the image information A1 on the real space) in step S2, judges the position and the shape of the real object 311 based on the real space information (e.g., the depth information A2 on the real object) in step S3, and sets the image information B1 on the virtual object 312 based on the position 91 of the viewpoint and the position and the shape of the real object 311 in step S4.

Subsequently, the virtual object display control device 10 in step S5 judges whether the guidance display is necessary or not based on the position 91 of the viewpoint, the position and the shape of the real object 311, and the image information B1 on the virtual object. In other words, the virtual object display control device 10 judges whether or not an image 322 of the virtual object 312 is hidden by an image 321 of the real object 311 as viewed from the position 91 of the viewpoint.

When the image 322 of the virtual object 312 is not hidden, the virtual object display control device 10 in step S6 draws the image 321 of the real object based on the image information on the real space and draws the image 322 of the virtual object. Then, the virtual object display control device 10 in step S7 makes the display device 30 display the image 321 of the real object and the image 322 of the virtual object.

When the image 322 of the virtual object 312 is hidden, the virtual object display control device 10 judges the position of the guidance display 323 in step S8, sets the image information on the guidance display in step S9, and draws the image 321 of the real object based on the image information on the real space and draws the image 322 of the virtual object and the image 323 of the guidance display in step S10. Then, the virtual object display control device 10 makes the display device 30 display the image 321 of the real object, the image 322 of the virtual object, and the image 323 of the guidance display. The guidance display 323 is, for example, an arrow indicating the direction of the virtual object. The guidance display 323 may include a message like “Here is a virtual object.” or “Here is comment on a virtual object.”, for example.

As described above, with the virtual object display system 1 and the virtual object display control device 10 according to the first embodiment, even when the image 322 of the virtual object is displayed at a position invisible from the observer 90, it is possible to allow the observer 90 to recognize the position of the image 322 of the virtual object by means of the guidance display 323.

Further, with the virtual object display system 1 and the virtual object display control device 10 according to the first embodiment, the position of the image 322 of the virtual object is not moved, and thus the observer 90 can correctly recognize about which real object the image 322 of the virtual object is.

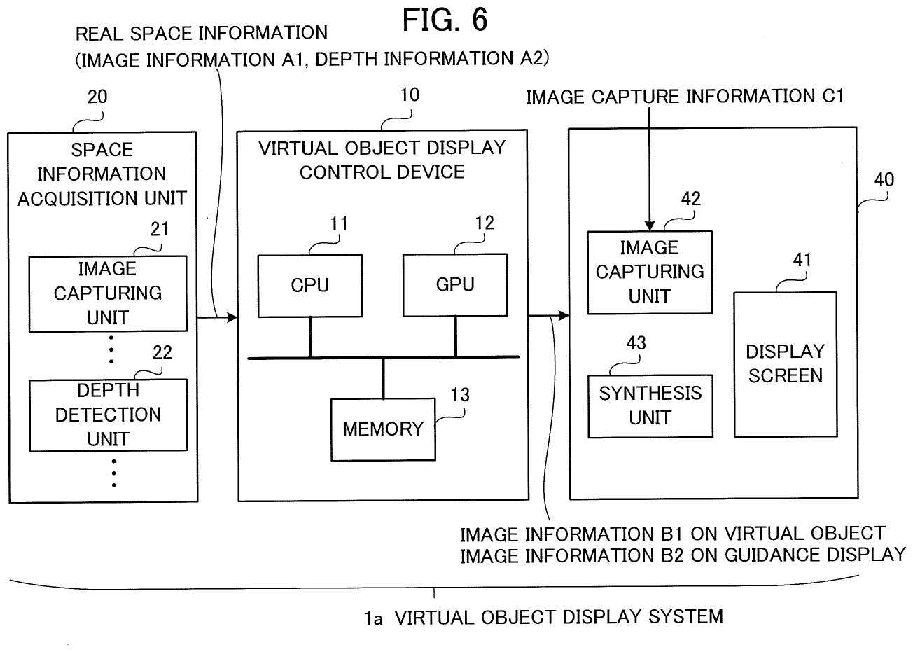

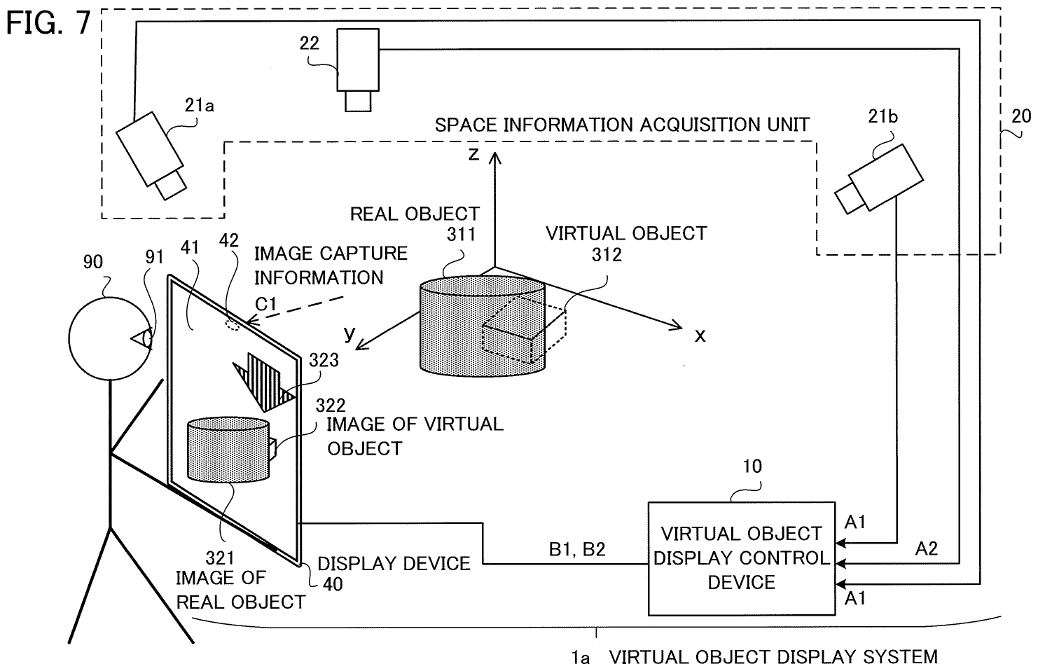

FIG. 6 is a diagram showing a hardware configuration of a virtual object display system 1a according to a modification of the first embodiment. In FIG. 6, each component identical or corresponding to a component shown in FIG. 1 is assigned the same reference character as in FIG. 1. FIG. 7 is an explanatory diagram showing the virtual object display system 1a of FIG. 6. In FIG. 7, each component identical or corresponding to a component shown in FIG. 4 is assigned the same reference character as in FIG. 4.

The virtual object display system 1a shown in FIG. 6 and FIG. 7 differs from the virtual object display system 1 shown in FIG. 1 in that a display device 40 includes an image capturing unit 42 that acquires image capture information C1 as viewed from the position 91 of the viewpoint, a display screen 41, and a synthesis unit 43 that makes the display screen 41 display an image in which the image information B1 on the virtual object and the image information B2 on the guidance display are superimposed on the image capture information C1.

In the virtual object display system 1a, the virtual object display control device 10 may receive the position 91 of the viewpoint of the observer 90 from the display device 40.

Further, in the virtual object display system 1a, the image capturing unit 42 of the display device 40 may be used as the image capturing unit of the space information acquisition unit 20.

Except for the above-described features, the virtual object display system 1a shown in FIG. 6 and FIG. 7 is the same as the virtual object display system 1 shown in FIG. 1 and FIG. 4.

### Second Embodiment

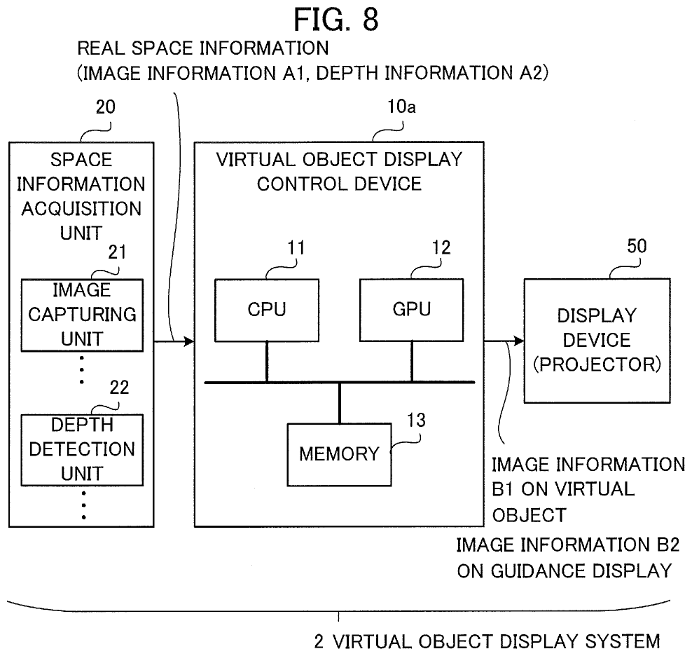

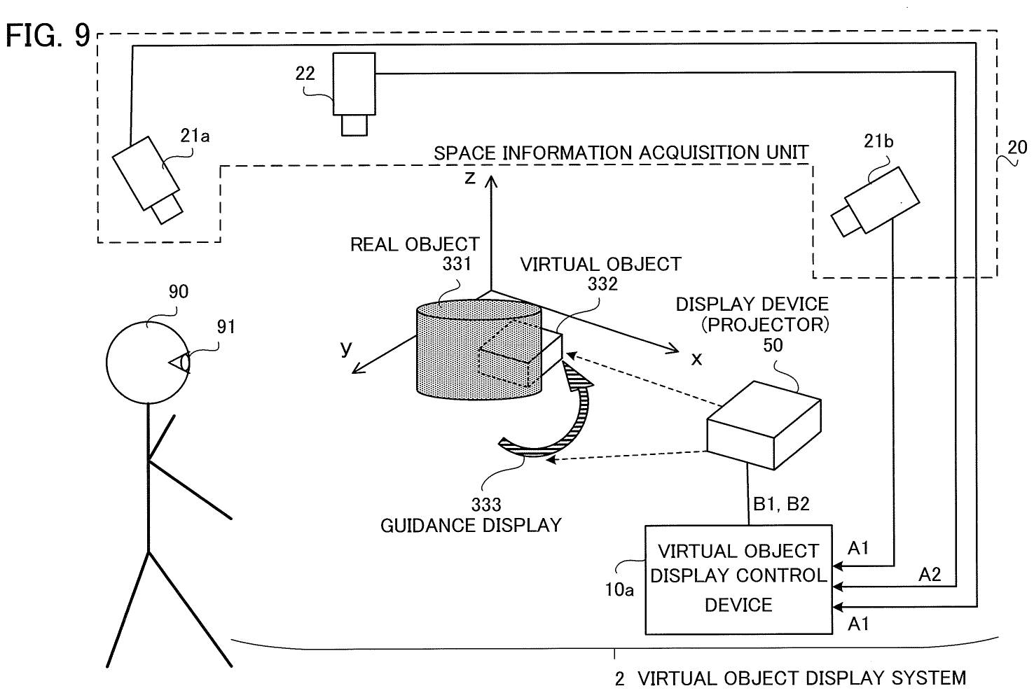

FIG. 8 is a diagram showing a hardware configuration of a virtual object display system 2 according to a second embodiment. In FIG. 8, each component identical or corresponding to a component shown in FIG. 1 is assigned the same reference character as in FIG. 1. FIG. 9 is an explanatory diagram showing the virtual object display system 2 of FIG. 8. In FIG. 9, each component identical or corresponding to a component shown in FIG. 4 is assigned the same reference character as in FIG. 4.

The virtual object display system 2 shown in FIG. 8 and FIG. 9 differs from the virtual object display system 1 shown in FIG. 1 and FIG. 4 in that a display device 50 is a projector that projects an image onto the real space (i.e., real world) and a guidance display 333 is a projection image displayed on a floor, a wall, a ceiling, a real object or the like in the real space. In the example of FIG. 9, the guidance display 333 is an arc-shaped arrow indicating a movement path of the observer 90.

As described above, with the virtual object display system 2 and a virtual object display control device 10a according to the second embodiment, even when the image 332 of the virtual object is displayed at a position invisible from the observer 90, it is possible to allow the observer 90 to recognize the position of the image 332 of the virtual object by means of the guidance display 333.

Further, with the virtual object display system 2 and the virtual object display control device 10a according to the second embodiment, the position of the image 332 of the virtual object is not moved, and thus the observer 90 can correctly recognize about which real object the image 332 of the virtual object is.

Furthermore, the intention of the guidance becomes easier to understand since the guidance display 333 is directly projected onto the real world and the space information on the real world is usable without change.

Except for the above-described features, the virtual object display system 2 shown in FIG. 8 and FIG. 9 is the same as the virtual object display system 1 shown in FIG. 1 and FIG. 4 or the virtual object display system 1a shown in FIG. 6 and FIG. 7.

### DESCRIPTION OF REFERENCE CHARACTERS

1, 1a, 2: virtual object display system, 10, 10a: virtual object display control device, 20: space information acquisition unit, 21, 21a, 21b: image capturing unit, 22: depth detection unit, 30, 40: display device, 31, 41: display screen, 42: image capturing unit, 43: synthesis unit, 50: display device (projector), 90: observer, 91: position of viewpoint, 110: recognition unit, 120: display control unit, 121: viewpoint position judgment unit, 122: real object judgment unit, 123: virtual object display setting unit, 124: guidance display judgment unit, 125: guidance display setting unit, 126: guidance display control unit, 127: drawing unit, 311: real object, 312: virtual object, 321: image of real object, 322, 332: image of virtual object, 323, 333: guidance display, A1: image information on real space, A2: depth information on real object, B1: image information on virtual object, B2: image information on guidance display.

1. A virtual object display control device comprising:
a processor to execute a program; and
a memory to store the program which, when executed by the processor, performs the processes of:
receiving real space information indicating a real space;
judging a position of a viewpoint of an observer based on the real space information;
judging a position and a shape of a real object based on the real space information;
setting image information on a virtual object based on the position of the viewpoint and the position and the shape of the real object;
judging whether a guidance display is necessary or not based on the position of the viewpoint, the position and the shape of the real object, and the image information on the virtual object and setting image information on the guidance display when the guidance display is necessary; and
outputting the image information on the virtual object and the image information on the guidance display,
wherein it is judged that the guidance display is necessary when a whole or part of the virtual object is hidden by the real object as viewed from the position of the viewpoint.

2. (canceled)

3. The virtual object display control device according to claim 1, wherein the real space information includes image information on the real space and depth information on the real object.

4. The virtual object display control device according to claim 1, wherein synthetic image information obtained by combining the image information on the virtual object and the image information on the guidance display with image information on the real space are outputted.

5. A virtual object display system comprising:
a camera to acquire real space information indicating a real space;
the virtual object display control device according to claim 1; and
a display device to display an image based on the image information on the virtual object and the image information on the guidance display.

6. The virtual object display system according to claim 5, wherein the camera acquires image information on the real space and depth information on the real object.

7. The virtual object display system according to claim 5, wherein the drawing unit outputs synthetic image information obtained by combining the image information on the virtual object and the image information on the guidance display with image information on the real space.

8. The virtual object display system according to claim 5, wherein the display device includes:
another camera to acquire image capture information as viewed from the position of the viewpoint; and
a display screen; and
wherein the display device makes the display screen display an image in which the image information on the virtual object and the image information on the guidance display are superimposed on the image capture information.

9. The virtual object display system according to claim 5, wherein the display device includes a projector that projects the image information on the virtual object and the image information on the guidance display onto the real space.

10. A virtual object display control method comprising the steps of:
receiving real space information indicating a real space;
judging a position of a viewpoint of an observer based on the real space information;
judging a position and a shape of a real object based on the real space information;
setting image information on a virtual object based on the position of the viewpoint and the position and the shape of the real object;
judging whether a guidance display is necessary or not based on the position of the viewpoint, the position and the shape of the real object, and the image information on the virtual object and setting image information on the guidance display when the guidance display is necessary; and
outputting the image information on the virtual object and the image information on the guidance display,
wherein, at the judging of whether the guidance display is necessary or not, it is judged that the guidance display is necessary when a whole or part of the virtual object is hidden by the real object as viewed from the position of the viewpoint.

11. A non-transitory computer-readable storage medium storing a virtual object display control program that causes a computer to execute:
receiving real space information indicating a real space;
judging a position of a viewpoint of an observer based on the real space information;
judging a position and a shape of a real object based on the real space information;
setting image information on a virtual object based on the position of the viewpoint and the position and the shape of the real object;
judging whether a guidance display is necessary or not based on the position of the viewpoint, the position and the shape of the real object, and the image information on the virtual object and setting image information on the guidance display when the guidance display is necessary; and
outputting the image information on the virtual object and the image information on the guidance display,
wherein, at the judging of whether the guidance display is necessary or not, it is judged that the guidance display is necessary when a whole or part of the virtual object is hidden by the real object as viewed from the position of the viewpoint.
